(19) United States
(12) Patent Application Publication
(10) Pub. No.: US 2026/0254120 A1
(43) Pub. Date: Aug. 27, 2026

(54) ANTENNA MODULE AND COMMUNICATION DEVICE EQUIPPED THEREWITH

(71) Applicant: Murata Manufacturing Co., Ltd., Nagaokakyo-shi (JP)

(72) Inventor: Kaoru SUDO, Nagaokakyo-shi (JP)

(73) Assignee: Murata Manufacturing Co., Ltd., Nagaokakyo-shi (JP)

(21) Appl. No.: 19/642,706

(22) Filed: Apr. 9, 2026

Related U.S. Application Data
(63) Continuation of application No. PCT/JP2024/037525, filed on Oct. 22, 2024.

(30) Foreign Application Priority Data
Dec. 15, 2023 (JP) 2023-211941

(51) Int. Cl. H01Q 13/08; H01Q 5/35; H01Q 23/00

(52) U.S. Cl. CPC H01Q 13/08; H01Q 5/35; H01Q 23/00

(57) ABSTRACT

An antenna module includes a radiating element having a planar shape, a ground electrode arranged so as to face the radiating element), first and second power feeding lines, and first and second band-stop filters. The first power feeding line is configured to transmit a radio frequency signal in a first frequency band to a first feed point of the radiating element. The second power feeding line is configured to transmit a radio frequency signal in a second frequency band higher than the first frequency band to a second feed point of the radiating element. The first filter is connected to the power feeding line and configured to inhibit passage of a radio frequency signal in the second frequency band. The second filter is connected to the second power feeding line and is configured to inhibit passage of a radio frequency signal in the first frequency band.

### CROSS-REFERENCE TO RELATED APPLICATIONS

This application is a continuation of International Application No. PCT/JP 2024/037525, filed on Oct. 22, 2024, which claims the benefit of priority to Japanese Patent Application No. 2023-211941, filed on Dec. 15, 2023. The entire contents of each of the above-identified applications are incorporated herein by reference.

### TECHNICAL FIELD

The present disclosure relates to an antenna module and a communication device equipped therewith, and more specifically to technology for radiating radio waves in multiple frequency bands using a single radiating element.

### BACKGROUND ART

International Publication No. 2023/100621 (Patent Document 1) discloses a so-called dual-band type antenna module that uses two different radiating elements stacked on a dielectric substrate to radiate radio waves in two respective frequency bands.

### CITATION LIST

### Patent Document

Patent Document 1: International Publication No. 2023/100621

### SUMMARY

An antenna module according to the present disclosure includes a radiating element having a planar shape, a ground electrode arranged so as to face the radiating element, a first power feeding line, a second power feeding line, a first band-stop filter, and a second band-stop filter. The first power feeding line transmits a radio frequency signal in a first frequency band to a first feed point of the radiating element. The second power feeding line transmits a radio frequency signal in a second frequency band higher than the first frequency band to a second feed point of the radiating element. The first band-stop filter is connected to the first power feeding line and configured to inhibit passage of a radio frequency signal in the second frequency band. The second band-stop filter is connected to the second power feeding line and configured to inhibit passage of a radio frequency signal in the first frequency band.

### Advantageous Effects

In the antenna module according to the present disclosure, the two power feeding lines (the first power feeding line, the second power feeding line) transmit radio frequency signals in different frequency bands from each other to the common radiating element. Furthermore, each power feeding line is provided with the band-stop filter configured to inhibit passage of a radio frequency signal transmitted through the other power feeding line. This configuration makes it possible to radiate radio waves in multiple frequency bands using a single radiating element while suppressing degradation of the antenna characteristics.

### BRIEF DESCRIPTION OF DRAWINGS

FIG. 1 is an overall configuration diagram of a communication device in which an antenna module according to a first embodiment is mounted.

FIG. 2 is a plan view of the antenna module according to the first embodiment.

FIG. 3 is a side cross-sectional view of the antenna module in FIG. 2.

FIG. 4 is a diagram illustrating antenna characteristics as viewed from each power feeding line in the antenna module in FIG. 2.

FIG. 5 is a plan view of an antenna module according to Modification 1.

FIG. 6 is a plan view of an antenna module according to Modification 2.

FIG. 7 is a plan view of an antenna module according to Modification 3.

FIG. 8 is a plan view of an antenna module according to Modification 4.

FIG. 9 is a plan view of an antenna module according to Modification 5.

FIG. 10 is a plan view of an antenna module according to Modification 6.

FIG. 11 is a plan view of an antenna module according to Modification 7.

FIG. 12 is a plan view of an antenna module according to Modification 8.

FIG. 13 is a side cross-sectional view of the antenna module according to Modification 8.

FIG. 14 is a plan view of an antenna module according to Modification 9.

FIG. 15 is a side cross-sectional view of the antenna module according to Modification 9.

FIG. 16 is a plan view of an antenna module according to Modification 10.

FIG. 17 is a side cross-sectional view of the antenna module according to Modification 10.

FIG. 18 is a plan view of an antenna module according to a second embodiment.

FIG. 19 is a plan view of an antenna module according to a third embodiment.

### DESCRIPTION OF EMBODIMENTS

In the antenna module disclosed in International Publication No. 2023/100621 (Patent Document 1), the two radiating elements are arranged so as to overlap each other when the dielectric substrate is viewed in plan view from its normal direction. In such a configuration, the centers of the radiating elements are to be aligned with each other. However, the inventors have recognized that if the two radiating elements are misaligned due to manufacturing variations and the like, this may cause the antenna characteristics to be degraded.

The present disclosure has been made to solve the issues as described above and others and is directed to providing an antenna module capable of radiating radio waves in multiple frequency bands using a single radiating element.

In the following, embodiments of the present disclosure will be described in detail with reference to the drawings. Note that identical or equivalent portions in the drawings are marked with the same symbols and description thereof will not be repeated.

### First Embodiment

### (Basic Configuration of Communication Device)

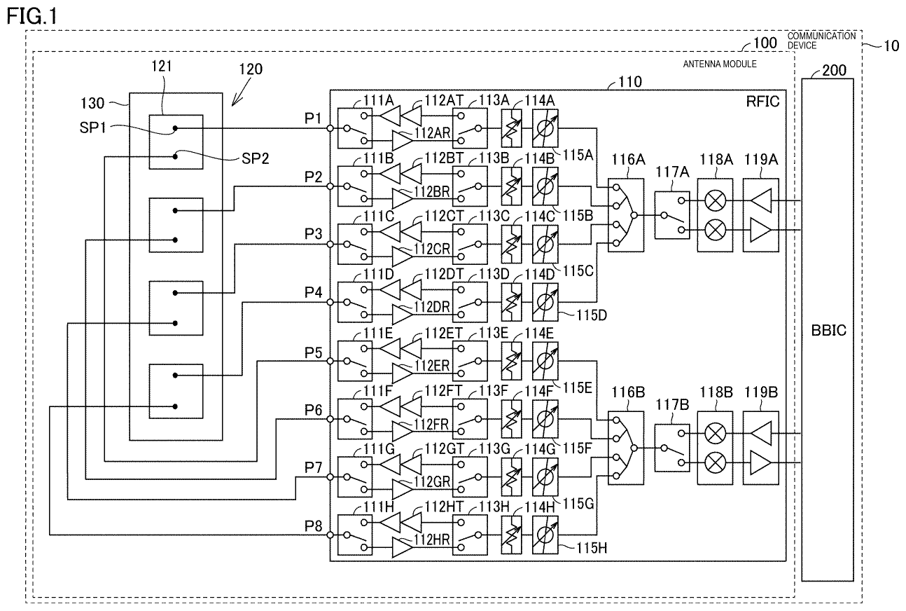

FIG. 1 is a block diagram of a communication device 10 to which an antenna module 100 according to the present embodiment is applied. The communication device 10 is, for example, a mobile terminal or a personal computer with communication functions. Examples of the mobile terminal include a cellular phone, a smartphone, and a tablet. An example of a frequency band of radio waves used by the antenna module 100 according to the present embodiment is a millimeter wave band. For example, radio waves in the millimeter wave band have center frequencies such as 28 GHz and 39 GHz. However, radio waves in frequency bands other than that described above are also applicable.

With reference to FIG. 1, the communication device 10 includes the antenna module 100 and a baseband integrated circuit (BBIC) 200 constituting a baseband signal processing circuit. The antenna module 100 includes a radio frequency integrated circuit (RFIC) 110, which is an example of a power feed circuit, and an antenna device 120.

The communication device 10 up-converts signals transmitted from the BBIC 200 to the antenna module 100 into radio frequency signals and radiates the radio frequency signals from the antenna device 120, and also down-converts radio frequency signals received by the antenna device 120 and processes the signals using the BBIC 200.

The antenna device 120 includes a dielectric substrate 130 and multiple radiating elements arranged in the dielectric substrate 130. FIG. 1 illustrates, as an example, a configuration in which four radiating elements 121 are arranged in the dielectric substrate 130; however, the number of radiating elements arranged in the dielectric substrate 130 is not limited to this. A single radiating element 121 or multiple radiating elements may be arranged in the dielectric substrate 130. In addition, FIG. 1 illustrates an example in which a one-dimensional array of radiating elements 121 arranged in a single row is arranged in the dielectric substrate 130; however, the radiating elements may be arranged in a two-dimensional array in the dielectric substrate 130.

In the first embodiment, each radiating element 121 is a microstrip antenna having a substantially planar square shape. Note that the shape of the radiating element 121 may be circular, elliptical, or polygonal.

Two feed points SP1 and SP2 are arranged on each radiating element 121, and radio frequency signals are individually supplied to each feed point from the RFIC 110. As described below, in the antenna module 100 according to the first embodiment, radio frequency signals in two different frequency bands are supplied to a single radiating element 121. In each radiating element 121, a radio frequency signal in a first frequency band on the low frequency side is supplied to the feed point SP1, and a radio frequency signal in a second frequency band on the high frequency side is supplied to the feed point SP2. Note that, in the example in the first embodiment, the first frequency band is the 28 GHz band (24.25 GHz to 29.5 GHz), and the second frequency band is the 39 GHz band (37 GHz to 43.5 GHz).

The RFIC 110 includes switches 111A to 111H, 113A to 113H, 117A, and 117B, power amplifiers 112AT to 112HT, low noise amplifiers 112AR to 112 HR, attenuators 114A to 114H, phase shifters 115A to 115H, signal multiplexing/demultiplexing devices 116A and 116B, mixers 118A and 118B, and amplification circuits 119A and 119B. Among these, the configurations of the switches 111A to 111D, 113A to 113D, and 117A, the power amplifiers 112AT to 112DT, the low noise amplifiers 112AR to 112DR, the attenuators 114A to 114D, the phase shifters 115A to 115D, the signal multiplexing/demultiplexing device 116A, the mixer 118A, and the amplification circuit 119A are circuits for radio frequency signals in the first frequency band. Moreover, the configurations of the switches 111E to 111H, 113E to 113H, and 117B, the power amplifiers 112ET to 112HT, the low noise amplifiers 112ER to 112HR, the attenuators 114E to 114H, the phase shifters 115E to 115H, the signal multiplexing/demultiplexing device 116B, the mixer 118B, and the amplification circuit 119B are circuits for radio frequency signals in the second frequency band.

In a case where radio frequency signals are to be transmitted, the switches 111A to 111H and 113A to 113H are switched to the power amplifiers 112AT to 112HT, and also the switches 117A and 117B are connected to the transmission-side amplifiers of the amplification circuits 119A and 119B. In a case where radio frequency signals are to be received, the switches 111A to 111H and 113A to 113H are switched to the low noise amplifiers 112AR to 112 HR, and also the switches 117A and 117B are connected to the reception-side amplifiers of the amplification circuits 119A and 119B.

Signals transmitted from the BBIC 200 are amplified by the amplification circuits 119A and 119B and are then up-converted by the mixers 118A and 118B. Transmission signals that are up-converted radio frequency signals are separated into four signals by the signal multiplexing/demultiplexing devices 116A and 116B, and the four signals pass through the corresponding signal paths and are fed to the radiating elements. By separately adjusting the degrees of phase shift of the phase shifters 115A to 115H arranged along the respective signal paths, the directivities of radio waves output from the radiating elements in each substrate can be adjusted. Moreover, the attenuators 114A to 114H adjust the strengths of transmission signals.

Terminals P1 to P4 of the switches 111A to 111D are connected to the feed points SP1 of the corresponding radiating elements 121. Terminals P5 to P8 of the switches 111E to 111H are connected to the feed points SP2 of the corresponding radiating elements 121.

Reception signals, which are radio frequency signals received by the radiating elements 121, are transmitted to the RFIC 110, travel along the four different respective signal paths, and are multiplexed by the signal multiplexing/demultiplexing devices 116A and 116B. The multiplexed reception signals are down-converted by the mixers 118A and 118B and then amplified by the amplification circuits 119A and 119B, and the resulting signals are transmitted to the BBIC 200.

The RFIC 110 is, for example, formed as a one-chip integrated circuit component including the above-described circuit configuration. Alternatively, the devices (the switches, the power amplifiers, the low noise amplifiers, the attenuators, the phase shifters) corresponding to each radiating element 121 in the RFIC 110 may be formed as a one-chip integrated circuit component for the corresponding radiating element.

### (Configuration of Antenna Module)

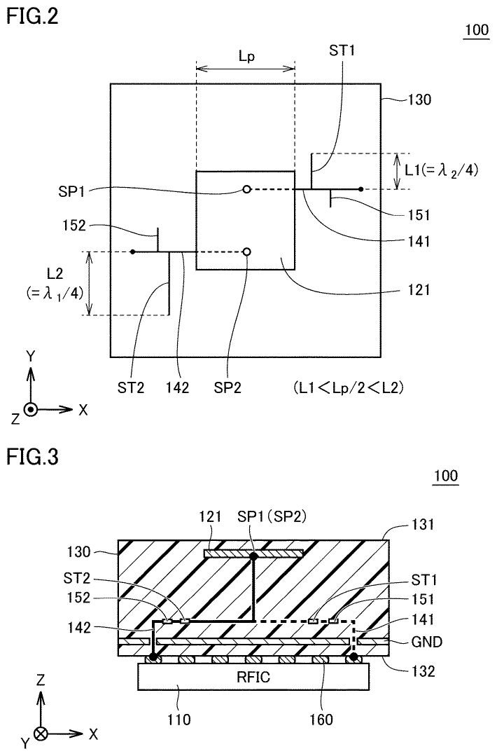

Next, the configuration of the antenna module 100 according to the first embodiment will be described in detail using FIGS. 2 and 3. FIG. 2 is a plan view of the antenna module 100, and FIG. 3 is a side cross-sectional view of the antenna module 100.

With reference to FIGS. 2 and 3, the antenna module 100 includes the dielectric substrate 130, a ground electrode GND, and power feeding lines 141 and 142 in addition to the radiating element 121 and the RFIC 110. Note that the dielectric of the dielectric substrate 130 is omitted in FIG. 2 and subsequent plan views.

The dielectric substrate 130 has a substantially rectangular parallelepiped shape that includes two rectangular-shaped principal surfaces 131 and 132 that face each other. Note that, in the following description, the normal direction of the principal surfaces 131 and 132 of the dielectric substrate 130 is the Z-axis direction. The direction along one side of each of the principal surfaces 131 and 132 of the dielectric substrate 130 is the X-axis direction, and the direction along another side thereof is the Y-axis direction. In each drawing, the positive Z-axis direction may also be referred to as the upper side and the negative Z-axis direction as the lower side.

The dielectric substrate 130 is, for example, a low temperature co-fired ceramics (LTCC) multilayer substrate, a multilayer resin substrate formed by laminating multiple resin layers consisting of epoxy, polyimide, and other resins, a multilayer resin substrate formed by laminating multiple resin layers composed of liquid crystal polymers (LCPs) having lower dielectric constants, a multilayer resin substrate formed by laminating multiple resin layers composed of fluorine-based resins, a multilayer resin substrate formed by laminating multiple resin layers composed of polyethylene terephthalate (PET) material, or a multilayer ceramic substrate other than LTCC multilayer substrates. Note that the dielectric substrate 130 does not have to have a multilayer structure and may be a single-layer substrate.

The dielectric substrate 130 has a rectangular shape as viewed in plan view from its normal direction (the Z-axis direction). The radiating element 121 is arranged at a position near the upper-side principal surface 131 of the dielectric substrate 130. The radiating element 121 may be arranged so as to be exposed on a surface of the dielectric substrate 130 or may also be arranged in an inner layer of the dielectric substrate 130 as in the example in FIG. 3.

In the dielectric substrate 130, the ground electrode GND is arranged closer to the principal surface 132 than the radiating element 121 is and over the entire surface so as to face the radiating element 121. The RFIC 110 is mounted on the principal surface 132 of the dielectric substrate 130 with solder bumps 160 interposed therebetween. Note that the RFIC 110 may be connected to the dielectric substrate 130 using a multipole connector instead of a solder connection.

In a case where the radiating element 121 is viewed in plan view from the Z-axis direction, the feed point SP1 is arranged at a position offset from the center of the radiating element 121 in the positive Y-axis direction, and the feed point SP2 is arranged at a position offset from the center of the radiating element 121 in the negative Y-axis direction. A radio frequency signal is supplied from the RFIC 110 to the feed point SP1 through the power feeding line 141. A radio frequency signal is supplied from the RFIC 110 to the feed point SP2 through the power feeding line 142. By supplying radio frequency signals to each of the feed point SP1 and the feed point SP2, radio waves polarized in the Y-axis direction are radiated in the positive Z-axis direction.

As described using FIG. 1, a radio frequency signal in the first frequency band on the relatively lower frequency side is supplied to the feed point SP1, and a radio frequency signal in the second frequency band on the relatively higher frequency side is supplied to the feed point SP2. That is, the antenna module 100 is a so-called dual-band type antenna module capable of radiating radio waves in two different frequency bands using a single radiating element. Note that the antenna module 100 can radiate radio waves of two frequencies alternately or simultaneously.

In the example in FIG. 2, the power feeding line 141 extends in the negative X-axis direction toward the radiating element 121 from a position in the positive X-axis direction relative to the radiating element 121, extends from behind the feed point SP1, and is connected to the feed point SP1. Moreover, the power feeding line 142 extends in the positive X-axis direction toward the radiating element 121 from a position in the negative X-axis direction relative to the radiating element 121, extends from behind the feed point SP2, and is connected to the feed point SP2. In this manner, by arranging the power feeding line 141 and the power feeding line 142 so as to extend in opposite directions with respect to the radiating element 121, the coupling between the power feeding line 141 and the power feeding line 142 can be suppressed. This can ensure isolation between the individual power feeding lines.

The power feeding lines 141 and 142 are provided with straight stubs ST1 and ST2, respectively. Each of the stubs ST1 and ST2 is an open stub having one end connected, e.g., directly connected, to a corresponding power feeding line and the other end open. Each of the stubs ST1 and ST2 serves as a band-stop filter for inhibiting transmission of signals in the frequency band of the other one. Thus, the line length of each of the stubs ST1 and ST2 is set to a length of one-quarter wavelength at the center frequency of the frequency band of a radio frequency signal supplied to the power feeding line of the other one.

More specifically, a line length L1 of the stub ST1 is set to L1=λ₂/4 when the wavelength of a radio frequency signal in the second frequency band supplied to the power feeding line 142 is λ₂ (a second wavelength). Similarly, a line length L2 of the stub ST2 is set to L2=λ₁/4 when the wavelength of a radio frequency signal in the first frequency band supplied to the power feeding line 141 is λ₁ (a first wavelength). Note that the shape of the stubs ST1 and ST2 may be a straight line as illustrated in FIG. 2 or may also be a bent shape such as an L-shape, for example.

Generally, the dimension of the radiating element 121 in the polarization direction is set to half the wavelength corresponding to the center frequency of a radio frequency signal to be radiated. The antenna module 100 uses a common radiating element 121 to radiate radio waves in two frequency bands as described above, and the resonant frequency of the radiating element 121 may be set between the frequencies of two radio waves. In other words, the wavelength corresponding to the resonant frequency of the radiating element 121 may be longer than the wavelength of a radio wave on the high frequency side and shorter than the wavelength of a radio wave on the low frequency side.

Specifically, in a case where the radiating element 121 is substantially square, a length Lp of one side of the radiating element 121 (namely, the length along the polarization direction) is set to satisfy L1<Lp/2<L2. If this relational expression is expressed using the wavelengths of radio waves to be radiated, λ₂/2<Lp<λ₁/2.

Note that, in practice, it is possible to radiate radio waves in two frequency bands from a single radiating element even in a case where the frequencies of two radio waves are both higher than the resonant frequency of the radiating element 121 or a case where the frequencies of two radio waves are both lower than the resonant frequency of the radiating element 121. However, in that case, the antenna characteristics for the one radio wave having a larger difference from the resonant frequency of the radiating element 121 may be degraded, compared with those for the other radio wave. Thus, the resonant frequency of the radiating element 121 may be set between the two frequency bands to be radiated.

Furthermore, the power feeding lines 141 and 142 may be provided with matching elements for adjusting the impedances between the power feeding lines 141 and 142 and the radiating element 121. In the example in FIG. 2, the power feeding line 141 is provided with a stub 151 serving as a matching element, and the power feeding line 142 is provided with a stub 152 serving as a matching element. Note that the impedances between the power feeding lines 141 and 142 and the radiating element 121 may vary depending on the positions of the stubs ST1 and ST2 connected to the power feeding lines 141 and 142. Thus, if the desired impedances can be achieved by the connection positions of the stubs ST1 and ST2, there may be a case where the stubs 151 and 152 for matching are not provided.

In the antenna module 100 having this configuration, in a case where a radio frequency signal on the low frequency side is supplied through the power feeding line 141, the stub ST2 serving as a band-stop filter makes it possible to prevent leakage of radio frequency signals to the power feeding line 142. In a case where a radio frequency signal on the high frequency side is supplied through the power feeding line 142, the stub ST1 makes it possible to prevent leakage of signals to the power feeding line 141. This makes it possible to radiate radio waves in two frequency bands using the common radiating element while ensuring isolation between the power feeding lines 141 and 142.

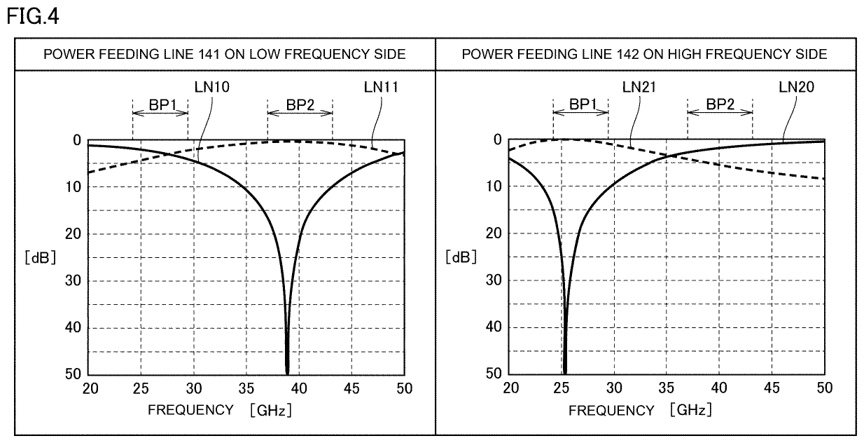

FIG. 4 is a diagram illustrating antenna characteristics as viewed from each of the power feeding lines 141 and 142 in the antenna module in FIG. 2. In FIG. 4, the horizontal axis represents frequency, and the vertical axis represents insertion loss (solid lines LN10, LN20) and return loss (dashed lines LN11, LN21). The left diagram of FIG. 4 illustrates antenna characteristics as viewed from the power feeding line 141, and the right diagram of FIG. 4 illustrates antenna characteristics as viewed from the power feeding line 142.

Regarding the power feeding line 141 through which radio frequency signals on the low frequency side are transmitted, as illustrated in the left diagram of FIG. 4, an attenuation pole occurs near 39 GHz, and an attenuation of 10 dB or more can be ensured in a frequency band BP2 on the high frequency side. This can inhibit radio frequency signals supplied to the power feeding line 142 from passing gthrough the power feeding line 141. In contrast, the insertion loss is 3 dB or less in a frequency band BP1 on the low frequency side, and radio frequency signals for radio waves to be radiated can be transmitted to the radiating element 121 with low loss.

Similarly, regarding the power feeding line 142 through which radio frequency signals on the high frequency side are transmitted, as illustrated in the right diagram of FIG. 4, an attenuation pole occurs near 25 GHz, and an attenuation of 10 dB or more can be ensured in the frequency band BP1 on the low frequency side. This can inhibit radio frequency signals supplied to the power feeding line 141 from passing through the power feeding line 142. In contrast, the insertion loss is 3 dB or less in the frequency band BP2 on the high frequency side, and radio frequency signals for radio waves to be radiated can be transmitted to the radiating element 121 with low loss.

Hitherto, as a dual-band type antenna module, a configuration has been known in which radiating elements corresponding to each frequency band are provided separately, and two radiating elements are arranged so as to be stacked in the normal direction of a dielectric substrate. However, with such a configuration, the antenna characteristics could be degraded due to misalignment of the two radiating elements caused by manufacturing variations.

However, as in the antenna module 100 according to the first embodiment, a dual-band type antenna module can be realized in which the degradation of antenna characteristics due to misalignment of radiating elements is suppressed by supplying radio frequency signals in two different frequency bands to a common radiating element. Furthermore, for each power feeding line, the degradation of antenna characteristics due to signal leakage can be suppressed while ensuring isolation between the power feeding lines 141 and 142 by providing a band-stop filter that inhibits passage of signals in the frequency band supplied to the other power feeding line.

The “power feeding line 141” and the “power feeding line 142” according to the first embodiment correspond to a “first power feeding line” and a “second power feeding line” according to the present disclosure, respectively. The “stub ST1” and the “stub ST2” according to the first embodiment correspond to a “first band-stop filter” and a “second band-stop filter” according to the present disclosure, respectively. The “frequency band BP1” and the “frequency band BP2” according to the first embodiment correspond to the “first frequency band” and the “second frequency band” according to the present disclosure, respectively. Each of the “stub 151” and the “stub 152” according to the first embodiment corresponds to a “matching element” according to the present disclosure.

### (Modification 1)

Different configurations of band-stop filters will be described in Modification 1 and Modification 2, which is to be described below.

FIG. 5 is a plan view of an antenna module 100A according to Modification 1. The antenna module 100A has a configuration in which the stubs ST1 and ST2 of the antenna module 100 in FIG. 2 are replaced with stubs ST1A and ST2A, respectively. Other configurations of the antenna module 100A are substantially the same as those of the antenna module 100, and descriptions of elements that are the same as those of the antenna module 100 will not be repeated.

With reference to FIG. 5, each of the stubs ST1A and ST2A is a short stub having one end portion connected to the ground electrode GND. That is, one end of the stub ST1A is connected to the power feeding line 141, and the other end is connected to the ground electrode GND. Similarly, one end of the stub ST2A is connected to the power feeding line 142, and the other end is connected to the ground electrode GND.

The stubs ST1A and ST2A serve as band-stop filters substantially in the same manner as the stubs ST1 and ST2 in the antenna module 100. Thus, the line length of each of the stubs ST1A and ST2A is set to half a wavelength corresponding to the frequency to be blocked.

More specifically, a line length L1A of the stub ST1A is set to L1A=λ₂/2 when the wavelength of a radio frequency signal in the second frequency band supplied to the power feeding line 142 is λ₂. Similarly, a line length L2A of the stub ST2A is set to L2A=λ₁/2 when the wavelength of a radio frequency signal in the first frequency band supplied to the power feeding line 141 is λ₁. When the length of one side of the radiating element 121 is Lp, it is set such that L1A<Lp<L2A.

In this manner, even in a case where a short stub is used as a band-stop filter, it is possible to realize a dual-band type antenna module using a common radiating element while ensuring isolation between the power feeding lines 141 and 142 and suppressing degradation of the antenna characteristics.

Note that, in the case of short stubs, the line lengths of the stubs are longer than in the case of the open stubs according to the first embodiment. Thus, in a case where the entire device needs to be miniaturized, it is more advantageous to use the open stubs according to the first embodiment.

The “stub ST1A” and the “stub ST2A” according to Modification 1 correspond to the “first band-stop filter” and the “second band-stop filter” according to the present disclosure, respectively.

### (Modification 2)

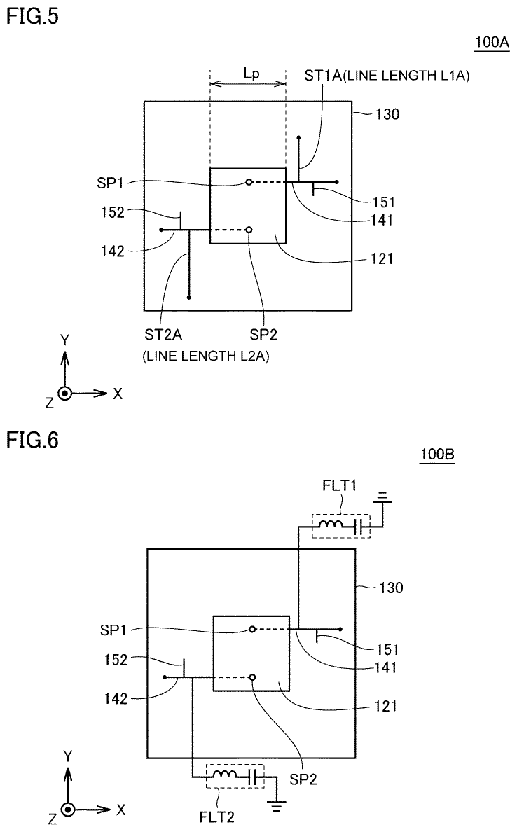

FIG. 6 is a plan view of an antenna module 100B according to Modification 2. The antenna module 100B has a configuration in which the stubs ST1 and ST2 of the antenna module 100 in FIG. 2 are replaced with filters FLT1 and FLT2, respectively. Other configurations of the antenna module 100B are substantially the same as those of the antenna module 100, and descriptions of elements that are the same as those of the antenna module 100 will not be repeated.

With reference to FIG. 6, each of the filters FLT1 and FLT2 is an inductor-capacitor (LC) resonator in which an inductor and a capacitor are connected in series. One end of the inductor of the filter FLT1 is connected to the power feeding line 141, and the other end thereof is connected to the ground electrode GND with the capacitor interposed therebetween. Similarly, one end of the inductor of the filter FLT2 is connected to the power feeding line 142, and the other end thereof is connected to the ground electrode GND with the capacitor interposed therebetween.

The inductance value of the inductor and capacitance value of the capacitor of the filter FLT1 are set such that the resonant frequency of the filter FLT1 is the center frequency of a radio frequency signal supplied to the power feeding line 142. Similarly, the inductance value of the inductor and capacitance value of the capacitor of the filter FLT2 are set such that the resonant frequency of the filter FLT2 is the center frequency of a radio frequency signal supplied to the power feeding line 141.

By setting the resonant frequencies of the LC resonators of the filters FLT1 and FLT2 in this manner, each of the filters FLT1 and FLT2 serves as a band-stop filter for radio frequency signals supplied through the other power feeding line.

In a case where the frequency band of radio waves to be radiated is relatively low, if stubs as in the first embodiment and Modification 1 are used, the line lengths become long, which may inhibit miniaturization of the dielectric substrate or cause the antenna characteristics to deteriorate due to the increased effect on the electric lines of force between the radiating element and the ground electrode. In such cases, LC filters installed outside the dielectric substrate can be used as band-stop filters to deal with the above-described issue.

The “filter FLT1” and the “filter FLT2” according to Modification 2 correspond to the “first band-stop filter” and the “second band-stop filter” according to the present disclosure, respectively.

### (Modification 3)

Other arrangement configurations of the power feeding lines will be described in Modification 3 and Modifications 4 and 5, which are to be described below.

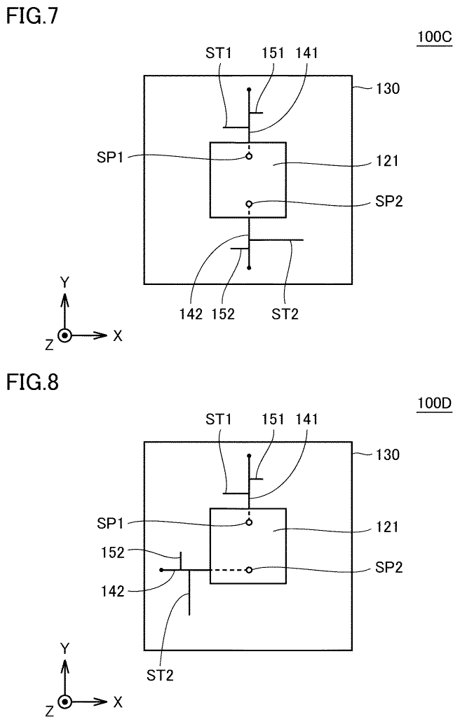

FIG. 7 is a plan view of an antenna module 100C according to Modification 3. In the antenna module 100 according to the first embodiment, when viewed in plan view from the normal direction of the dielectric substrate 130, the power feeding lines 141 and 142 are arranged so as to extend in opposite directions from the feed points in the direction (the X-axis direction) orthogonal to the polarization direction (the Y-axis direction) of radio waves radiated from the radiating element 121. In the antenna module 100C, the power feeding lines 141 and 142 are arranged so as to extend in opposite directions from the feed points in the same direction as the polarization direction (namely, the Y-axis direction).

Even in this arrangement of the power supply lines, the separation distance between the power feeding line 141 and the power feeding line 142 can be maintained, thereby suppressing coupling between the power feeding lines.

### (Modification 4)

FIG. 8 is a plan view of an antenna module 100D according to Modification 4. In the antenna module 100 according to the first embodiment and the antenna module 100C according to Modification 3, the two power feeding lines 141 and 142 are arranged along the same direction. In the antenna module 100D, the two power feeding lines 141 and 142 are arranged along directions that intersect each other.

More specifically, in the antenna module 100D, the power feeding line 141 is arranged along the polarization direction (namely, the Y-axis direction) from the feed point SP1, and the power feeding line 142 is arranged along the direction orthogonal to the polarization direction (namely, the X-axis direction) from the feed point SP2. Note that the extending directions of the power feeding line 141 and the power feeding line 142 do not necessarily have to be orthogonal as long as they intersect each other.

In this manner, the power feeding lines are arranged along directions that intersect each other from the respective feed points, which makes it possible to suppress coupling between the power feeding lines.

Note that, in contrast to FIG. 8, the power feeding line 141 may be arranged along the direction orthogonal to the polarization direction, and the power feeding line 142 may be arranged along the polarization direction.

### (Modification 5)

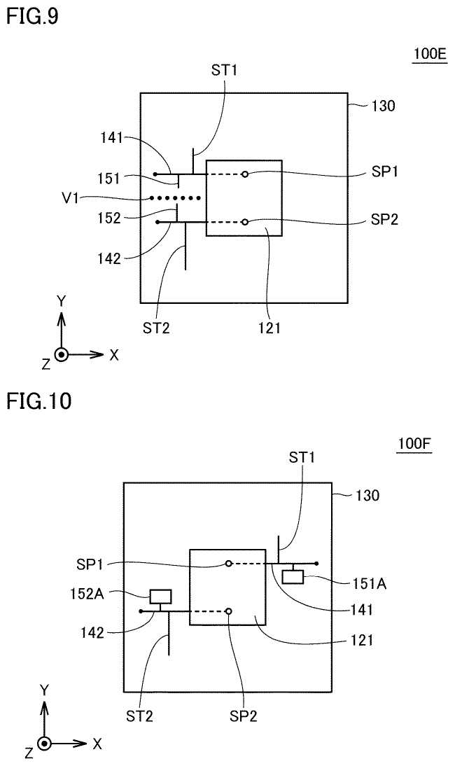

FIG. 9 is a plan view of an antenna module 100E according to Modification 5. In the antenna module 100E, the power feeding line 141 and the power feeding line 142 are arranged so as to extend in the same direction from the feed points SP1 and SP2. Specifically, in the example in FIG. 9, the power feeding lines 141 and 142 are arranged in parallel along the negative X-axis direction from the feed points SP1 and SP2.

In addition to that, in the antenna module 100E, when viewed in plan view from the normal direction of the dielectric substrate 130, multiple vias V1 extending in that normal direction are arranged between the power feeding line 141 and the power feeding line 142. The multiple vias V1 are arrayed along the X-axis direction in the same manner as the power feeding lines 141 and 142 and are connected to the ground electrode GND. This allows the multiple vias V1 to serve as a shield. Thus, even in a case where, for example, design constraints require that power feeding lines be arranged in parallel in the same direction from the radiating element, coupling between the power feeding line 141 and the power feeding line 142 can be suppressed.

### (Modification 6)

In Modification 6, another configuration of matching elements for impedance matching with the radiating element will be described.

FIG. 10 is a plan view of an antenna module 100F according to Modification 6. In the antenna module 100F, planar electrodes 151A and 152A connected to the power feeding lines 141 and 142, respectively, are provided instead of the stubs 151 and 152 serving as matching elements in the antenna module 100 according to the first embodiment.

Each of the planar electrodes 151A and 152A is arranged so as to face the ground electrode GND, forming a capacitor with the ground electrode GND. By changing the area of each planar electrode to adjust the capacitance value, the impedance between the corresponding power feeding line and the radiating element 121 can be matched.

Note that, similar to the stubs 151 and 152 in the antenna module 100, the planar electrodes 151A and 152A are not necessarily essential. The planar electrodes 151A and 152A do not have to be provided as long as desired impedances can be achieved by adjusting, for example, the connection positions of the stubs ST1 and ST2.

Each of the “planar electrode 151A” and the “planar electrode 152A” in Modification 6 corresponds to a “matching element” according to the present disclosure.

### (Modification 7)

In Modification 7, a configuration will be described in which impedances are adjusted using the positions of the feed points of the radiating element 121.

FIG. 11 is a plan view of an antenna module 100G according to Modification 7. In the antenna module 100G, the distance from a center CP of the radiating element 121 to the feed point SP1 on the low frequency side and the distance from the center CP to the feed point SP2 on the high frequency side are different. In the example in FIG. 11, the feed point SP1 has a longer distance from the center CP than the feed point SP2 does, and is arranged closer to an end portion of the radiating element 121. In the polarization direction, the electric field becomes stronger toward the end portion of the radiating element 121, and thus the impedance becomes higher as the feed point is positioned closer to the end portion of the radiating element 121.

Thus, adjustments to desired impedances can be made even using the positions of the feed points SP1 and SP2 of the radiating element 121, instead of or in addition to the positions of the stubs ST1 and ST2 connected to the power feeding lines and matching elements such as the stubs 151 and 152.

### (Modification 8)

In Modification 8 and Modifications 9 and 10, which are to be described below, configurations will be described in which power is fed to the radiating element by using capacitive coupling.

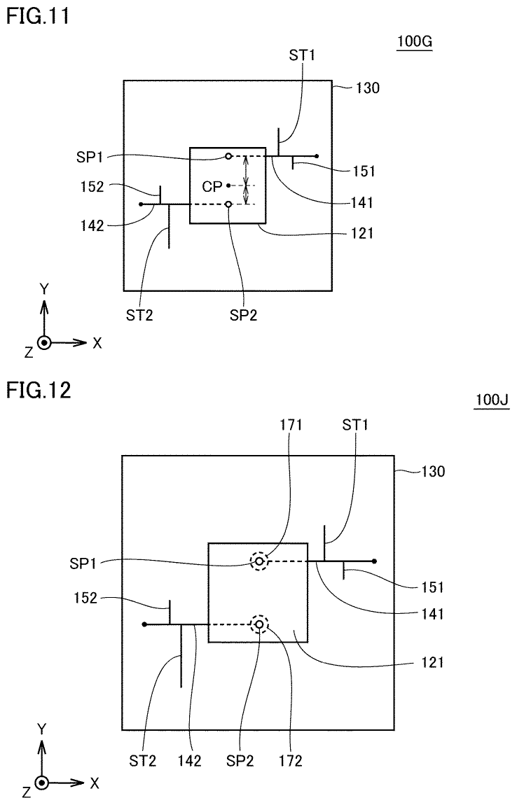

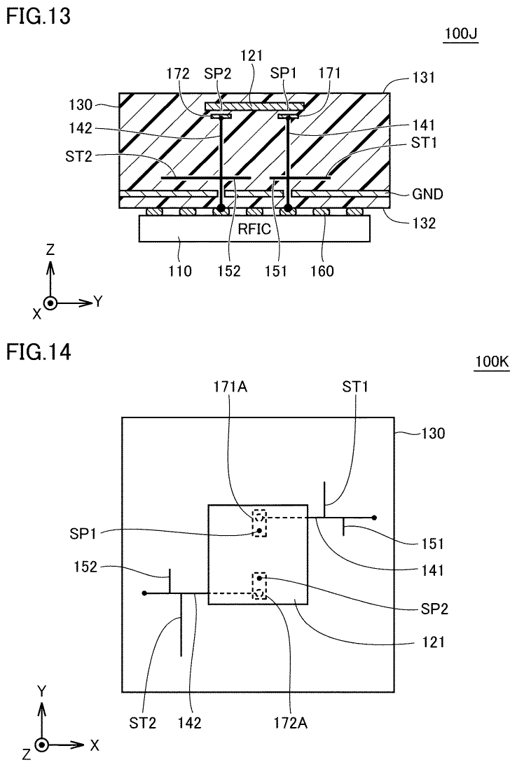

FIG. 12 is a plan view of an antenna module 100J according to Modification 8. FIG. 13 is a side cross-sectional view of the antenna module 100J as viewed from the X-axis direction. The antenna module 100J has a configuration obtained by adding planar electrodes 171 and 172 to the antenna module 100 according to the first embodiment.

With reference to FIGS. 12 and 13, the planar electrodes 171 and 172 have a circular shape when the dielectric substrate 130 is viewed in plan view from the Z-axis direction, and overlap the feed points SP1 and SP2 of the radiating element 121, respectively. As illustrated in FIG. 13, the planar electrodes 171 and 172 are spaced apart and arranged at positions corresponding to the feed points SP1 and SP2, respectively, in a dielectric layer near the lower side of the radiating element 121. The power feeding line 141 is connected to the planar electrode 171, and the power feeding line 142 is connected to the planar electrode 172.

When radio frequency signals are supplied to the power feeding lines 141 and 142, the radio frequency signals are transmitted to the feed points SP1 and SP2, respectively, in accordance with capacitive coupling between the planar electrodes 171 and 172 and the radiating element 121.

Even in this type of power feeding method, for each power feeding line, the degradation of antenna characteristics due to signal leakage can be suppressed while ensuring isolation between the power feeding lines 141 and 142 by providing a band-stop filter that inhibits passage of signals in a frequency band supplied to the other power feeding line.

### (Modification 9)

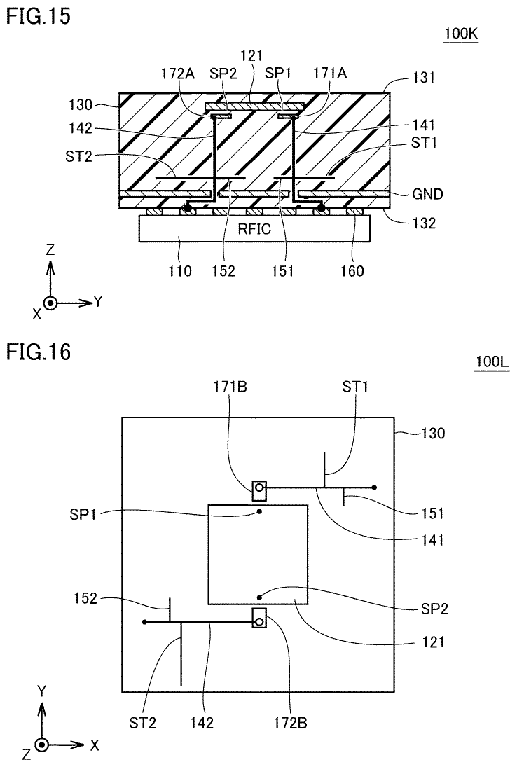

FIG. 14 is a plan view of an antenna module 100K according to Modification 9. FIG. 15 is a side cross-sectional view of the antenna module 100K as viewed from the X-axis direction. The antenna module 100K has a configuration obtained by replacing the planar electrodes 171 and 172 of the antenna module 100J described in Modification 8 with planar electrodes 171A and 172A.

With reference to FIGS. 14 and 15, the planar electrodes 171A and 172A have a substantially rectangular shape whose sides along the polarization direction are long sides when the dielectric substrate 130 is viewed in plan view from the Z-axis direction. In the example in FIG. 14, the planar electrodes 171A and 172A have long sides along the Y-axis. The planar electrode 171A extends in the positive Y-axis direction from a position facing the feed point SP1. The planar electrode 172A extends in the negative Y-axis direction from a position facing the feed point SP2.

As illustrated in FIG. 15, the planar electrodes 171A and 172A are arranged at positions corresponding to the feed points SP1 and SP2 of the radiating element 121, respectively, so as to be spaced apart from the feed points SP1 and SP2 in a dielectric layer near the lower side of the radiating element 121. The power feeding line 141 is connected to a position of the planar electrode 171A that does not overlap the feed point SP1 when the dielectric substrate 130 is viewed in plan view. Similarly, the power feeding line 142 is connected to a position of the planar electrode 172A that does not overlap the feed point SP2 when the dielectric substrate 130 is viewed in plan view.

When radio frequency signals are supplied to the power feeding lines 141 and 142, the radio frequency signals are transmitted to the feed points SP1 and SP2, respectively, in accordance with capacitive coupling between the planar electrodes 171A and 172A and the radiating element 121.

In this manner, in each of the planar electrodes 171A and 172A, the impedance between the power feeding line and the radiating element can be adjusted by providing an offset in the polarization direction between the position to which the corresponding power feeding line is connected and the power feeding position of the radiating element 121.

Even in the antenna module 100K, for each power feeding line, the degradation of antenna characteristics due to signal leakage can be suppressed while ensuring isolation between the power feeding lines 141 and 142 by providing a band-stop filter that inhibits passage of signals in the frequency band supplied to the other power feeding line.

### (Modification 10)

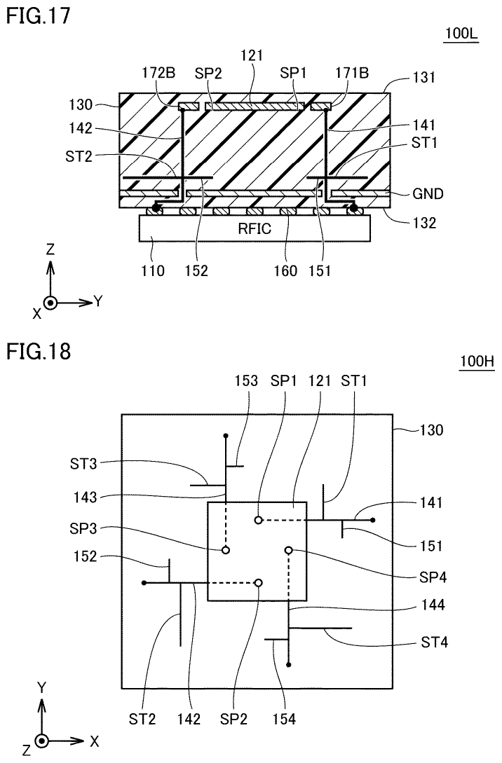

FIG. 16 is a plan view of an antenna module 100L according to Modification 10. FIG. 17 is a side cross-sectional view of the antenna module 100L as viewed from the X-axis direction. The antenna module 100L has a configuration obtained by replacing the planar electrodes 171 and 172 of the antenna module 100J described in Modification 8 with planar electrodes 171B and 172B.

With reference to FIGS. 16 and 17, the planar electrodes 171B and 172B has a substantially rectangular shape whose sides along the polarization direction are long sides when the dielectric substrate 130 is viewed in plan view from the Z-axis direction. In the example in FIG. 16, the planar electrodes 171B and 172B have sides along the Y-axis as their long sides.

The planar electrodes 171B and 172B are spaced apart from the radiating element 121 and are arranged in the same dielectric layer as the radiating element 121. More specifically, the planar electrode 171B is arranged so as to face a center portion of the side of the radiating element 121 located in the positive Y-axis direction. The planar electrode 172B is arranged so as to face a center portion of the side of the radiating element 121 located in the negative Y-axis direction.

The power feeding line 141 is connected to the planar electrode 171B, and the power feeding line 142 is connected to the planar electrode 172B. In this case, the feed point SP1 is the portion of the radiating element 121 facing the planar electrode 171B, and the feed point SP2 is the portion of the radiating element 121 facing the planar electrode 172B.

By supplying a radio frequency signal to the power feeding line 141, the radio frequency signal is transmitted to the feed point SP1 of the radiating element 121 through the planar electrode 171B using capacitive coupling. Similarly, by supplying a radio frequency signal to the power feeding line 142, the radio frequency signal is transmitted to the feed point SP2 of the radiating element 121 through the planar electrode 172B using capacitive coupling.

In this manner, since the radiating element 121 and the planar electrodes 171B and 172B for power feeding can be arranged in the same dielectric layer by feeding power using capacitive coupling through the planar electrodes 171B and 172B arranged in the same dielectric layer as the radiating element 121, the number of dielectric layers in the dielectric substrate 130 can be reduced.

Even in the antenna module 100L, for each power feeding line, the degradation of antenna characteristics due to signal leakage can be suppressed while ensuring isolation between the power feeding lines 141 and 142 by providing a band-stop filter that inhibits passage of signals in the frequency band supplied to the other power feeding line.

### Second Embodiment

In a second embodiment, a configuration will be described in which the features of the present application are applied to a so-called dual-polarization type antenna module capable of radiating radio waves in each frequency band in two different polarization directions.

FIG. 18 is a plan view of an antenna module 100H according to the second embodiment. The antenna module 100H is provided with power feeding lines 143 and 144 for transmitting radio frequency signals to feed points SP3 and SP4 of the radiating element 121, in addition to the configuration of the antenna module 100 according to the first embodiment. Regarding the antenna module 100H, description of the elements that are also included in the antenna module 100 will not be repeated.

With reference to FIG. 18, the feed point SP3 is arranged at a position offset from the center of the radiating element 121 in the negative X-axis direction, and the feed point SP4 is arranged at a position offset from the center of the radiating element 121 in the positive X-axis direction. By supplying radio frequency signals to the feed points SP3 and SP4, radio waves polarized in the X-axis direction are radiated in the positive Z-axis direction.

The power feeding line 143 for transmitting radio frequency signals in the first frequency band on the low frequency side is connected to the feed point SP3. The power feeding line 143 is arranged so as to extend from the feed point SP3 in the positive Y-axis direction when viewed in plan view from the normal direction of the radiating element 121. A stub ST3 serving as a band-stop filter that inhibits the passage of radio frequency signals in the second frequency band is arranged along the power feeding line 143. The stub ST3 is an open stub, and its line length is set to λ₂/4 when the wavelength of radio frequency signals in the second frequency band is λ₂. The power feeding line 143 may be provided with a stub 153 for adjusting the impedance between the power feeding line 143 and the radiating element 121.

The power feeding line 144 for transmitting radio frequency signals in the second frequency band on the high frequency side is connected to the feed point SP4. The power feeding line 144 is arranged so as to extend from the feed point SP4 in the negative Y-axis direction when viewed in plan view from the normal direction of the radiating element 121. A stub ST4 serving as a band-stop filter that inhibits the passage of radio frequency signals in the first frequency band is arranged along the power feeding line 144. The stub ST4 is an open stub, and its line length is set to λ₁/4 when the wavelength of radio frequency signals in the first frequency band is λ₁. The power feeding line 144 may be provided with a stub 154 for adjusting the impedance between the power feeding line 144 and the radiating element 121.

In this manner, by supplying radio frequency signals in the first frequency band to the feed points SP1 and SP3 and radio frequency signals in the second frequency band to the feed points SP2 and SP4, radio waves whose polarization directions are the X-axis direction and the Y-axis direction in each frequency band can be radiated from the radiating element 121.

The stubs ST1 and ST3, which inhibit the passage of signals in the second frequency band, are arranged along the power feeding lines 141 and 143, respectively. The stubs ST2 and ST4, which inhibit the passage of signals in the first frequency band, are arranged along the power feeding lines 142 and 144, respectively. This makes it possible to radiate radio waves in two frequency bands in two polarization directions using a common radiating element while ensuring isolation between the power feeding lines. Note that the antenna module 100H can also simultaneously radiate radio waves in the two frequency bands in two polarization directions.

The features of Modifications 1 to 7 described above can also be applied as appropriate to the power feeding lines 143 and 144 to the extent that no contradictions arise.

The “power feeding line 143” and the “power feeding line 144” according to the second embodiment correspond to a “third power feeding line” and a “fourth power feeding line” according to the present disclosure, respectively. The “stub ST3” and the “stub ST4” according to the second embodiment correspond to a “third band-stop filter” and a “fourth band-stop filter” according to the present disclosure, respectively.

### Third Embodiment

In a third embodiment, a configuration will be described in which radio frequency signals in two frequency bands are supplied to one feed point of a radiating element via a diplexer.

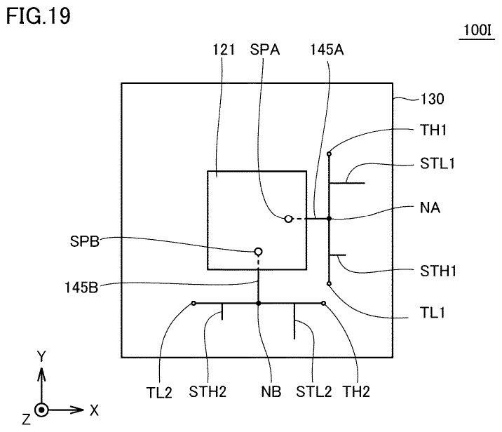

FIG. 19 is a plan view of an antenna module 100I according to the third embodiment. In the radiating element 121 of the antenna module 100I, a feed point SPA is arranged at a position offset from the center of the radiating element 121 in the positive X-axis direction, and a feed point SPB is arranged at a position offset from the center of the radiating element 121 in the negative Y-axis direction. A power feeding line 145A is connected to the feed point SPA, and a power feeding line 145B is connected to the feed point SPB.

When viewed in plan view from the normal direction of the radiating element 121, the power feeding line 145A extends from the feed point SPA in the positive X-axis direction, branches in two directions at a branch node NA, and is connected to a terminal TL1 and a terminal TH1. A radio frequency signal in the first frequency band on the low frequency side is supplied to the terminal TL1. A radio frequency signal in the second frequency band on the high frequency side is supplied to the terminal TH1.

A stub STH1 serving as a band-stop filter for inhibiting the passage of radio frequency signals in the second frequency band is connected to the line between the terminal TL1 and the branch node NA. A stub STL1 serving as a band-stop filter for inhibiting the passage of radio frequency signals in the first frequency band is connected to the line between the terminal TH1 and the branch node NA. That is, the stubs STH1 and STL1 constitute a diplexer.

The stub STH1 can prevent radio frequency signals in the second frequency band from leaking to the terminal TL1. Similarly, the stub STL1 can prevent radio frequency signals in the first frequency band from leaking to the terminal TH1. Radio waves polarized in the X-axis direction in the two frequency bands can be radiated from the radiating element 121 by supplying a radio frequency signal in the first frequency band to the terminal TL1 and supplying a radio frequency signal in the second frequency band to the terminal TH1.

In other words, the above-described configuration can be interpreted as a configuration in which the power feeding lines 141 and 142 according to the first embodiment are connected to the same feed point.

When viewed in plan view from the normal direction of the radiating element 121, the power feeding line 145B extends from the feed point SPB in the negative Y-axis direction, branches in two directions at a branch node NB, and is connected to a terminal TL2 and a terminal TH2. A radio frequency signal in the first frequency band on the low frequency side is supplied to the terminal TL2. A radio frequency signal in the second frequency band on the high frequency side is supplied to the terminal TH2.

A stub STH2 serving as a band-stop filter for inhibiting the passage of radio frequency signals in the second frequency band is connected to the line between the terminal TL2 and the branch node NB. A stub STL2 serving as a band-stop filter for inhibiting the passage of radio frequency signals in the first frequency band is connected to the line between the terminal TH2 and the branch node NB. That is, the stubs STH2 and STL2 constitute a diplexer.

The stub STH2 can prevent radio frequency signals in the second frequency band from leaking to the terminal TL2. Similarly, the stub STL2 can prevent radio frequency signals in the first frequency band from leaking to the terminal TH2. Radio waves polarized in the Y-axis direction in the two frequency bands can be radiated from the radiating element 121 by supplying a radio frequency signal in the first frequency band to the terminal TL2 and supplying a radio frequency signal in the second frequency band to the terminal TH2.

The above-described configuration makes it possible for the antenna module 100I to radiate radio waves in two frequency bands in two respective polarization directions using a common radiating element. Provision of the stubs STL1, STL2, STH1, and STH2 serving as band-stop filters can suppress leakage of radio frequency signals supplied to each power feeding line.

Note that, the power feeding lines 145A and 145B may be provided with matching elements for adjusting the impedance between each power feeding line and the radiating element 121.

The embodiments disclosed herein are to be considered exemplary and not restrictive in all respects. The scope of the present invention is represented by the claims, not by the description of the embodiments described above, and is intended to include all changes within the meaning and scope of the claims and those of equivalents of the claims.

### REFERENCE SIGNS LIST

10 communication device
100, 100A to 100L antenna module
110 RFIC
111A to 111H, 113A to 113H, 117A, 117B switch
112AR to 112 HR low noise amplifier
112AT to 112HT power amplifier
114A to 114H attenuator
115A to 115H phase shifter
116A, 116B signal multiplexing/demultiplexing device
118A, 118B mixer
119A, 119B amplification circuit
120 antenna device
121 radiating element
130 dielectric substrate
131, 132 principal surface
141 to 1424, 145A, 145B power feeding line
151 to 154, ST1 to ST4, ST1A, ST2A, STL1, STL2, STH1, STH2 stub
151A, 152A, 171, 172, 171A, 172A, 171B, 172B planar electrode
160 solder bump
200 BBIC
CP center
FLT1, FLT2 filter
GND ground electrode
NA, NB branch node
P1 to P8, TH1, TH2, TL1, TL2 terminal
SP1 to SP4, SPA, SPB feed point
V1 via

1. An antenna module comprising:
a radiating element having a planar shape;
a ground electrode arranged so as to face the radiating element;
a first power feeding line configured to transmit a radio frequency signal in a first frequency band to a first feed point of the radiating element;
a second power feeding line configured to transmit a radio frequency signal in a second frequency band higher than the first frequency band to a second feed point of the radiating element;
a first band-stop filter connected to the first power feeding line and configured to inhibit passage of a radio frequency signal in the second frequency band; and
a second band-stop filter connected to the second power feeding line and configured to inhibit passage of a radio frequency signal in the first frequency band.

2. The antenna module according to claim 1, wherein each of the first band-stop filter and the second band-stop filter is a stub having a first end connected to a corresponding power feeding line, and
a line length of the first band-stop filter is shorter than a line length of the second band-stop filter.

3. The antenna module according to claim 2, wherein each of the first band-stop filter and the second band-stop filter is an open stub having a second end that is open,
the first feed point is arranged at a position that is offset from a center of the radiating element in a first direction,
the second feed point is arranged at a position that is offset from the center of the radiating element in a second direction,
half a length of the radiating element along the first direction is longer than the line length of the first band-stop filter, and
half a length of the radiating element along the second direction is shorter than the line length of the second band-stop filter.

4. The antenna module according to claim 2, wherein each of the first band-stop filter and the second band-stop filter is a short stub having a second end connected to the ground electrode,
the first feed point is arranged at a position that is offset from a center of the radiating element in a first direction,
the second feed point is arranged at a position that is offset from the center of the radiating element in a second direction,
a length of the radiating element along the first direction is longer than the line length of the first band-stop filter, and
a length of the radiating element along the second direction is shorter than the line length of the second band-stop filter.

5. The antenna module according to claim 3, wherein the second direction is opposite to the first direction with respect to the center of the radiating element.

6. The antenna module according to claim 3, wherein the second direction intersects the first direction at the center of the radiating element.

7. The antenna module according to claim 3, further comprising:
a dielectric substrate on or in which the radiating element and the ground electrode are arranged, wherein
when a wavelength of a signal corresponding to the first frequency band in the dielectric substrate is a first wavelength and a wavelength of a signal corresponding to the second frequency band in the dielectric substrate is a second wavelength,
a length of the radiating element along the first direction is shorter than half the first wavelength, and
a length of the radiating element along the second direction is longer than half the second wavelength.

8. The antenna module according claim 2, wherein a distance from a center of the radiating element to the first feed point is different from a distance from the center of the radiating element to the second feed point.

9. The antenna module according to claim 1, wherein each of the first band-stop filter and the second band-stop filter is an inductor-capacitor (LC) filter.

10. The antenna module according to claim 1, wherein when viewed in plan view from a normal direction of the radiating element, an extending direction of the first power feeding line from the first feed point is different from an extending direction of the second power feeding line from the second feed point.

11. The antenna module according to claim 1, further comprising: a matching element provided along at least one of the first power feeding line and the second power feeding line.

12. The antenna module according to claim 11, wherein the matching element is a stub having one end connected to a corresponding power feeding line.

13. The antenna module according to claim 11, wherein the matching element is a planar electrode connected to a corresponding power feeding line and arranged so as to face the ground electrode.

14. The antenna module according to claim 1, further comprising:
a power feed circuit configured to output radio frequency signals to the first power feeding line and the second power feeding line, wherein
the power feed circuit is configured to output radio frequency signals individually to the first power feeding line and the second power feeding line.

15. The antenna module according to claim 1, further comprising: a third power feeding line configured to transmit a radio frequency signal in the first frequency band to a third feed point of the radiating element;
a fourth power feeding line configured to transmit a radio frequency signal in the second frequency band to a fourth feed point of the radiating element;
a third band-stop filter connected to the third power feeding line and configured to inhibit passage of a radio frequency signal in the second frequency band; and
a fourth band-stop filter connected to the fourth power feeding line and configured to inhibit passage of a radio frequency signal in the first frequency band, wherein
the first feed point is arranged at a position that is offset from a center of the radiating element in a first direction,
the second feed point is arranged at a position that is offset with respect to the center of the radiating element in a second direction opposite to the first direction,
the third feed point is arranged at a position that is offset in a third direction that intersects the first direction at the center of the radiating element, and
the fourth feed point is arranged at a position that is offset with respect to the center of the radiating element in a fourth direction opposite to the third direction.

16. The antenna module according to claim 1, wherein
the first band-stop filter is directly connected to the first power feeding line, and
the second band-stop filter is directly connected to the second power feeding line.

17. The antenna module according to claim 1, wherein
the first and second feed point are a common feed point,
the first power feeding line and the second power feeding line are connected to the common feed point of the radiating element via a branch node at which the first power feeding line and the second power feeding line meet, and the first band-stop filter is connected to the first power feeding line between the branch node and a first terminal configured to receive a radio frequency signal in the first frequency band, and
the second band-stop filter is connected to the second power feeding line between the branch node and a second terminal configured to receive a radio frequency signal in the second frequency band,
wherein the first band-stop filter and the second band-stop filter together constitute a diplexer.

18. A communication device comprising: the antenna module according to claim 1.

19. An antenna module comprising:
a radiating element having a planar shape;
a ground electrode arranged so as to face the radiating element;
a first power feeding line configured to transmit a radio frequency signal in a first frequency band to a first feed point of the radiating element;
a second power feeding line configured to transmit a radio frequency signal in a second frequency band higher than the first frequency band to a second feed point of the radiating element;
a third power feeding line configured to transmit a radio frequency signal in the first frequency band to a third feed point of the radiating element;
a fourth power feeding line configured to transmit a radio frequency signal in the second frequency band to a fourth feed point of the radiating element;
a first band-stop filter connected to the first power feeding line and a second band-stop filter connected to the second power feeding line; and
a third band-stop filter connected to the third power feeding line and a fourth band-stop filter connected to the fourth power feeding line, wherein
the first and second feed points are arranged to radiate radio waves in a first polarization direction, and
the third and fourth feed points are arranged to radiate radio waves in a second polarization direction different from the first polarization direction.
